(19) United States
(12) Patent Application Publication
(10) Pub. No.: US 2007/0003860 A1
(43) Pub. Date: Jan. 4, 2007

(54) Substrate adhesion improver for photosensitive resin composition and photosensitive resin composition containing the same

(76) Inventors: Takashi Takeda, Hyogo (JP); Satoshi Kobayashi, Saitama-shi (JP); Dong-Myung Shin, Daejeon City (KR)

Correspondence Address: AZ ELECTRONIC MATERIALS USA CORP.;ATTENTION: INDUSTRIAL PROPERTY DEPT., 70 MEISTER AVENUE, SOMERVILLE, NJ, 08876, US

(21) Appl. No.: 10/551,211

(22) PCT Filed: Apr. 5, 2004
(86) PCT No.: PCT/JP04/04920

§ 371 Date: Sep. 28, 2005

(30) Foreign Application Priority Data
Apr. 11, 2003 (JP) 2003-107191

(51) Int. Cl. G03C 1/00

(52) U.S. Cl. 430/270.1

(57) ABSTRACT

This invention provides an improver for adhesion of a photosensitive resin composition consisting of an N-phenyl-2H-benzotriazole compound represented by the general formula (1) below. This improver is added for example to a photosensitive resin composition containing an alkali-soluble resin and a photosensitizer: 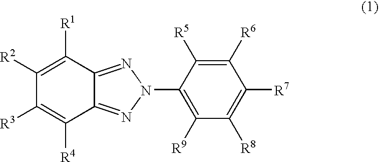
wherein R¹ to R⁴ each independently represent a hydrogen atom, a halogen atom or a C₁₋₅ alkyl group; R⁵ to R⁹ each independently represent a hydrogen atom, a hydroxyl group, a C₁₋₁₀ alkyl group, an aryl group, a C₇₋₁₂ aralkyl group, —R¹⁰COOR¹¹, or —R¹⁰CO—(OCH₂CH₂)n-OH provided that at least one of R⁵ and R⁹ is a hydroxyl group; R¹⁰ represents a C₂₋₅ alkylene group; R¹¹ represents a C₁₋₈ alkyl group; and n is an integer of 2 to 20.

### TECHNICAL FIELD

The present invention relates to an improver for adhesion of a photosensitive resin composition to a substrate and a photosensitive resin composition comprising the improver for adhesion of a photosensitive resin composition to a substrate. In particular, the present invention relates to an adhesion improver applied to improve the adhesion of a photosensitive resin composition to a silicon or glass substrate or a substrate having a film of metal such as molybdenum (Mo), a metal oxide film or a non-metal oxide film thereon, in manufacturing of a semiconductor integrated circuit element and a flat panel display (FPD) such as a liquid crystal display element, as well as a photosensitive resin composition comprising the adhesion improver.

### BACKGROUND ART

Lithographic technology is so far applied in fine processing, for example in manufacturing of a semiconductor integrated circuit element such as IC and LSI, a color filter, and a flat panel display (FPD) such as a liquid crystal display element. In recent years, fine processing in the order of submicron or quarter micron is required, and lithographic technology enabling such fine processing are being advanced.

In such lithographic technology, a resist pattern is formed on a substrate usually by the following method. That is, an anti-reflective film is first formed if necessary on a substrate, and then a positive- or negative-working photosensitive resin composition is applied thereon and heat-treated (pre-baked) to form a photoresist film. Thereafter, this photoresist film is subjected to a pattern-wise exposure to light with various radiations such as ultraviolet rays, far ultraviolet rays, electron beams and X rays, and then developed to form a resist pattern. As the method of applying the photosensitive resin composition, various methods such as spin coating, roll coating, land coating, flowing and spreading coating, doctor coating, dipping coating and slit coating are applied.

The resist pattern thus obtained is applied not only as a mask for etching or ion implantation, but also as a filter forming material in manufacturing of a color filter. A positive-working photosensitive resin composition is often applied as a resist material in manufacturing of a semiconductor integrated circuit element, and spin coating is often applied as the coating method. The positive-working photosensitive resin composition is also often applied as a resist material as well, in manufacturing of a flat panel display (FPD) such as a liquid crystal display element.

Conventionally, a silicon or glass substrate has been applied as a substrate in manufacturing of a semiconductor device such as IC and LSI, a thin film transistor (TFT), or a liquid crystal display element. A metal film, a non-metal film, a metal oxide film, a non-metal oxide film or the like are laid on a substrate. Examples of the film which is laid on the substrate include an amorphous silicon film, a polysilicon film, a silicon nitride film, a silicon oxide film, an indium tin oxide (ITO), tin oxide, Al, Ta, Mo, Cr, etc. These films are arranged by methods such as CVD, sputtering, vacuum deposition, thermal oxidization, etc. The photosensitive resin composition is applied onto a substrate material or a substrate material containing the substrate film material, to form a resist pattern on the substrate. The resulting resist pattern is applied for example as a protective film (mask) dry etching or wet etching to form a fine uneven pattern on the substrate.

In the photo-etching method described above, the adhesion between the applied photosensitive composition or the formed resist pattern and the substrate is known to be important for accurate etching of the metal film etc. on the substrate. This is because when the adhesion between the photosensitive resin composition and the substrate is not good, the formed resist pattern collapse or peeling-off upon pattern-wise exposure to light or development of the photoresist film formed by applying the photosensitive resin composition. Further, when the adhesion between the resist pattern and the substrate is not good, a pattern collapse and a peeling-off may occur at the time of etching. Upon such pattern collapse and peeling, defects such as cutoff or short of wiring formed by etching occur to cause the problem of a reduction in yield in mass manufacturing. Pattern defects attributable to lack of the adhesion of the photosensitive resin composition to the substrate occur particularly easily where the film to be coated with the photosensitive resin composition is a Mo or Ta film.

In order to improve the adhesion between the photosensitive resin composition and the substrate, addition of an adhesion improver to the photosensitive resin composition is known in the art. Known examples of improvements in the adhesion of the photosensitive resin achieved by the adhesion improver include, for example, improvements in the adhesion between a positive-working photoresist composition and a substrate by incorporating benzimidazoles or polybenzimidazole into the positive-working photoresist composition (see, for example, JP-A 6-27657) and improvements in the adhesion between a positive- or negative-working photoresist composition and a substrate by adding specific benzotriazoles to the positive- or negative-working photoresist composition (see, for example, JP-A 2000-171968 and JP-A 8-339087). In either case, however, there is a problem that the shelf stability of the photoresist composition is deteriorated and adhesion under severe conditions is not sufficient, and at present there is demand for further improvements.

An object of the present invention is to provide an improver for adhesion of a photosensitive resin composition to a substrate, which is free of the above-described problems in the prior art, as well as a photosensitive resin composition comprising the same.

That is, an object of the present invention is to provide an improver for adhesion of a photosensitive resin composition to a substrate, which upon addition to a photosensitive resin composition, is extremely excellent in the ability to confer adhesion to a substrate without a reduction in the shelf stability of the added photosensitive resin composition.

Another object of the present invention is to provide a photosensitive resin composition having excellent adhesion to a substrate, which comprises the above-described improver for adhesion of a photosensitive resin composition to a substrate.

A still further object of the present invention is to provide an improver for adhesion of a photosensitive resin composition to a substrate, which is excellent in adhesion to metal, non-metal, a metal oxide film and a non-metal oxide film serving as a substrate at the time of development and etching, can be subjected to etching accurately, and can contribute to improvements in yield in mass manufacturing, as well as a photosensitive resin composition comprising the same.

### DISCLOSURE OF INVENTION

As a result of extensive study and investigation, the present inventors found that an N-phenyl-2H-benzotriazole compound can be applied as an improver for adhesion of a photosensitive resin composition to a substrate thereby achieving these objects to complete the present invention.

That is, the present invention relates to an improver for adhesion of a photosensitive resin composition to a substrate, which consists of an N-phenyl-2H-benzotriazole compound represented by the following general formula (1): 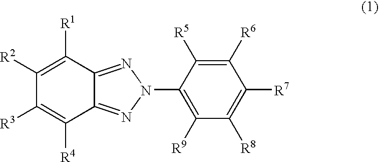
wherein R¹ to R⁴ independently represent a hydrogen atom, a halogen atom or a C₁₋₅ alkyl group; R⁵ to R⁹ independently represent a hydrogen atom, a hydroxyl group, a C₁₋₁₀ alkyl group, an aryl group, a C₇₋₁₂ aralkyl group, —R¹⁰COOR¹¹, or —R¹⁰CO—(OCH₂CH₂)n-OH provided that at least one of R⁵ and R⁹ is a hydroxyl group; R¹⁰ represents a C₂₋₅ alkylene group; R¹¹ represents a C₁₋₈ alkyl group; and n is an integer of 2 to 20.

Further, the present invention relates to a photosensitive resin composition containing an alkali-soluble resin and a photosensitizer, which comprises at least one of N-phenyl-2H-benzotriazole compounds represented by the above general formula (1).

Hereinafter, the present invention will be described in more detail.

The improver for adhesion of a photosensitive resin composition to a substrate according to the present invention is not particularly limited insofar as it is an N-phenyl-2H-benzotriazole compound represented by the general formula (1). The N-phenyl-2H-benzotriazole compound represented by the general formula (1) can be produced according to a manufacturing method known in the art. The N-phenyl-2H-benzotriazole compound represented by the general formula (1) includes, for example, 2-(3,5-di-t-butyl-2-hydroxyphenyl)-2H-benzotriazole represented by the formula (2) below, 2-(2-hydroxy-5-t-butylphenyl)-2H-benzotriazole represented by the formula (3) below, 2-(2H-benzotriazol-2-yl)-p-cresol represented by the formula (4) below, 2-(2H-benzotriazol-2-yl)-4,6-di-t-pentylphenol represented by the formula (5) below, 2-(2H-benzotriazol-2-yl)-4,6-bis(1-methyl-1-phenylethyl)phenol represented by the formula (6) below, 2-(2H-benzotriazol-2-yl)-6-(1-methyl-1-phenylethyl)-4-(1,1,3,3-tetramethylbutyl)phenol represented by the formula (7) below, benzenepropionic acid, 3-(2H-benzotriazol-2-yl)-5-(1,1-dimethylethyl)-4-hydroxy-, C₇₋₉-branched or linear alkyl ester represented by, for example, the formula (8) below, α-[3-[3-(2H-benzotriazol-2-yl)-5-(1,1-dimethylethyl)-4-hydroxyphenyl]-1-oxopropyl]-ω-hydroxy-poly(oxo-1,2-ethanediyl) represented by, for example, the formula (9) below, and octyl-3-[3-t-butyl-4-hydroxy-5(5-chloro-2H-benzotriazol-2-yl)phenyl]propionate represented by the formula (10) below.

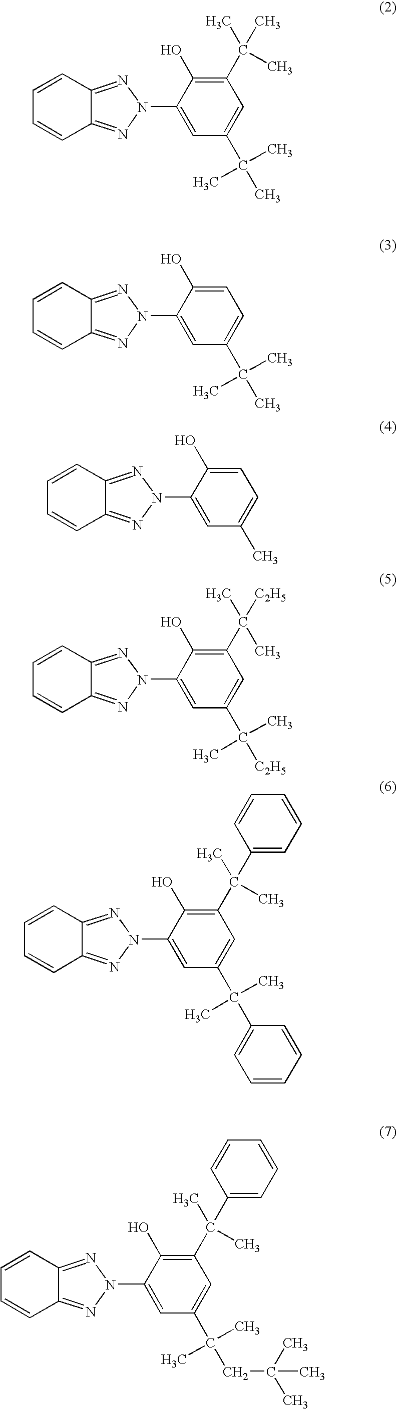

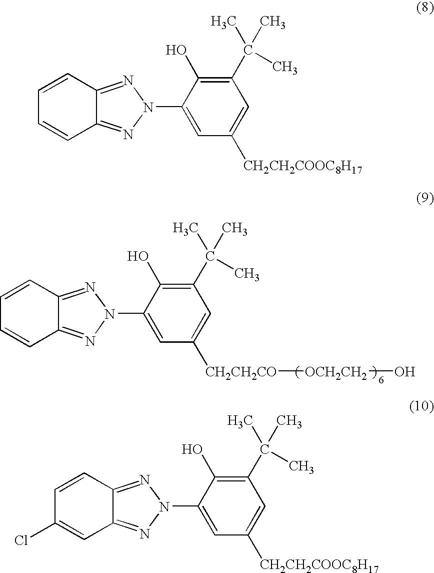

Among these compounds, 2-(3,5-di-t-butyl-2-hydroxyphenyl)-2H-benzotriazole is on sale by e.g. Lancaster (United Kingdom), easily commercially available and exhibits an excellent adhesion improving property, and thus it is a preferable compound serving as the improver for adhesion of a photosensitive resin composition according to the present invention.

The amount of the improver for adhesion of a photosensitive resin composition to a substrate according to the present invention is usually 10 to 50,000 ppm, preferably 100 to 5,000 ppm, based on the resin solid content of a photosensitive resin composition. When the amount of the improver for adhesion of a photosensitive resin composition to a substrate is less than 10 ppm, the adhesion-improving effect is not exhibited, while when the amount thereof is more than 50,000 ppm, there arise problems such as pattern formation defects attributable to development defects, reduction of sensitivity, generation of sublimated substance, etc.

The reason that the N-phenyl-2H-benzotriazole compound upon addition to a photosensitive resin composition, particularly to a photosensitive resin composition comprising an alkali-soluble resin and a photosensitizer, exhibits characteristics superior to those of a conventional adhesion improver is estimated as follows. However, the present invention is not limited thereby.

That is, the N-phenyl-2H-benzotriazole compound contains nitrogen atoms having affinity for a metal film or an oxide film. Because of its aromatic cyclic structure and its bound phenyl group, a non-covalent electron pair on these nitrogen atoms is considered to have a significantly higher activity than in other analogous nitrogenous heterocyclic compounds such as imidazole and imidazoline. The N-phenyl-2H-benzotriazole compound has 3 nitrogen atoms having such higher activity, and is structurally more balanced than other compounds containing two or four nitrogen atoms. By substitution of the phenyl group, the N-phenyl-2H-benzotriazole compound as compared with analogous benzotriazole compounds has high affinity for a base polymer, and thus has affinity for both a metal or oxide film and a base polymer. From these reasons, it can be considered that addition of the N-phenyl-2H-benzotriazole compound represented by the general formula (1) to a photosensitive resin composition leads to improvements in the adhesion between the photosensitive resin composition and the metal or oxide film.

The alkali-soluble resin in the photosensitive resin composition in the present invention includes, for example, novolak resin, a vinyl polymer having a phenolic hydroxyl group, and a vinyl polymer having a carboxyl group, among which the novolak resin is preferable. The alkali-soluble novolak resin is a novolak phenol resin obtained by polycondensation of at least one kind of phenol with an aldehyde such as formaldehyde.

The phenols applied in producing this alkali-soluble novolak resin include, for example, cresols such as o-cresol, p-cresol and m-cresol; xylenols such as 3,5-xylenol, 2,5-xylenol, 2,3-xylenol and 3,4-xylenol; trimethyl phenols such as 2,3,4-trimethyl phenol, 2,3,5-trimethyl phenol, 2,4,5-trimethyl phenol and 3,4,5-trimethyl phenol; t-butyl phenols such as 2-t-butyl phenol, 3-t-butylphenol and 4-t-butyl phenol; methoxy phenols such as 2-methoxy phenol, 3-methoxy phenol, 4-methoxy phenol, 2,3-dimethoxy phenol, 2,5-dimethoxy phenol and 3,5-dimethoxy phenol; ethyl phenols such as 2-ethyl phenol, 3-ethyl phenol, 4-ethyl phenol, 2,3-diethyl phenol, 3,5-diethyl phenol, 2,3,5-triethyl phenol and 3,4,5-triethyl phenol; chlorophenols such as o-chlorophenol, m-chlorophenol, p-chlorophenol and 2,3-dichlorophenol; resorcinols such as resorcinol, 2-methyl resorcinol, 4-methyl resorcinol and 5-methyl resorcinol; catechols such as 5-methyl catechol; pyrogallols such as 5-methyl pyrogallol; bisphoenols such as bisphenols A, B, C, D, E and F; methylol cresols such as 2,6-dimethylol-p-cresol; and naphthols such as α-naphthol and β-naphthol. These can be applied alone or as a mixture of two or more thereof.

The aldehydes include not only formaldehyde but also salicyl aldehyde, paraformaldehyde, acetaldehyde, benzaldehyde, hydroxybenzaldehyde and chloroacetaldehyde, and these can be applied alone or as a mixture of two or more thereof.

On the other hand, the alkali-soluble novolak resin may be the one from which low-molecular components were fractionated and removed or the one from which low-molecular components were neither fractionated nor removed. The method of fractionating and removing low-molecular components in the novolak resin includes, for example, a liquid-liquid fractionation method of fractionating novolak resin in two solvents different in solubility, and a method of removing low-molecular components by centrifugation.

The photosensitizer is typically a photosensitizer containing a quinonediazide group. The photosensitizer containing a quinonediazide group may be any known photosensitizer applied conventionally in quinonediazido-novolak resists. The photosensitizer is preferably a compound obtained by reaction of a quinonediazidosulfonic acid halide such as naphthoquinonediazidosulfonic acid chloride or benzoquinonediazidosulfonic acid chloride and a low- or high-molecular compound having a functional group capable of condensation reaction with the acid halide. The functional group which can be condensed with the acid halide includes a hydroxyl group, an amino group etc., among which a hydroxyl group is preferable. The compound containing a hydroxyl group capable of condensation reaction with the acid halide includes, for example, hydroquinone, resorcin, hydroxybenzophenones such as 2,4-dihydroxybenzophenone, 2,3,4-trihydroxybenzophenone, 2,4,6-trihydroxybenzophenone, 2,4,4′-trihydroxybenzophenone, 2,3,4,4′-tetrahydroxybenzophenone, 2,2′,4,4′-tetrahydroxybenzophenone and 2,2′,3,4,6′-pentahydroxybenzophenone, hydroxyphenyl alkanes such as bis(2,4-dihydroxyphenyl)methane, bis(2,3,4-trihydroxyphenyl)methane and bis(2,4-dihydroxyphenyl)propane, and hydroxytripenylmethane such as 4,4′,3″,4″-tetrahydroxy-3,5,3′,5′-tetramethyltriphenylme thane and 4,4′,2″,3″,4″-pentahydroxy-3,5,3′,5′-tetramethyltriphen ylmethane. These compounds can be applied alone, or two or more thereof can be applied in combination. The amount of the photosensitizer containing a quinonediazido group is usually 5 to 50 parts by weight, preferably 10 to 40 parts by weight, relative to 100 parts by weight of the alkali-soluble resin.

The solvent for the photosensitive resin composition of the present invention includes ethylene glycol monoalkyl ethers such as ethylene glycol monomethyl ether, ethylene glycol monoethyl ether, etc., ethylene glycolmonoalkyl ether acetates such as ethylene glycol monomethyl ether acetate, ethylene glycol monoethyl ether acetate, etc., propylene glycol monoalkyl ethers such as propylene glycol monomethyl ether, propylene glycol monoethyl ether, etc., propylene glycol monoalkyl ether acetates such as propylene glycol monomethyl ether acetate, propylene glycol monoethyl ether acetate, etc., lactates such as methyl lactate, ethyl lactate, etc., aromatic hydrocarbons such as toluene, xylene, etc., ketones such as methyl ethyl ketone, 2-heptanone, cyclohexanone, etc., amides such as N,N-dimethylacetamide, N-methylpyrrolidone, etc., and lactones such as γ-butyrolactone etc. These solvents can be applied alone or as a mixture of two or more thereof.

The photosensitive resin composition of the present invention can be compounded if necessary with a dye, an adhesive aid, etc. Examples of the dye include Methyl Violet, Crystal Violet, Malachite Green, etc., and examples of the adhesive aid include alkyl imidazoline, butyric acid, alkyl acid, polyhydroxystyrene, polyvinyl methyl ether, t-butyl novolak, epoxy silane, epoxy polymer, silane, etc.

The photosensitive resin composition of the present invention is produced by dissolving the alkali-soluble resin, the photosensitizer, the N-phenyl-2H-benzotriazole compound represented by the general formula (1), and another additive if necessary in a predetermined amount of a solvent and filtering the mixture through a filter if necessary. The photosensitive resin composition thus produced is applied onto substrates for manufacturing of a semiconductor integrated circuit element, a color filter, and FPD such as liquid crystal display element. The substrates onto which the photosensitive resin composition of the present invention is applied include arbitrary substrates having an arbitrary size, such as glass substrates and silicon substrates. The substrates may be those having a film such as a chromium film, a silicon oxide film, etc. formed thereon. The substrates may be coated with the photosensitive resin composition by any known conventional methods such as spin coating, roll coating, land coating, flowing and spreading coating, doctor coating, dipping coating and slit coating. The photosensitive resin composition is applied onto the substrate and then pre-baked to form a photoresist film. Then, the photoresist film is exposed to light and developed in a method conventionally known or well-known in the art to form a resist pattern excellent in shape without varying line width.

The developing agent applied in development may be an arbitrary developing agent applied in conventional photosensitive resin compositions. Preferable examples of the developing agent include alkali developing agents, that is, aqueous solutions of alkaline compounds such as tetraalkylammoniumhydroxide, choline, alkalimetalhydroxides, alkali metal metasilicates (hydrate), alkali metal phosphates (hydrate), ammonia water, alkylamines, alkanolamines and heterocyclic amines, and an aqueous solution of tetramethylammonium hydroxide is particularly preferable as the alkali developing solution. If necessary, these alkali developing solutions may contain water-soluble organic solvents such as methanol and ethanol or surfactants. After development with the alkali developing solution, water washing is usually carried out.

### BEST MODE FOR CARRYING OUT THE INVENTION

Hereinafter, the present invention will be described in more detail by reference to Examples, but the present invention is not limited by the Examples.

### Example 1

To novolak resin having a 15,000 weight-average molecular weight as determined by polystyrene standards were added 15 parts by weight of an esterification product of 1,2-naphthoquinonediamide-5-sulfonyl chloride with 2,3,4,4′-tetrahydroxybenzophenone based on 100 parts by weight of the novolak resin, 300 ppm of a fluorine-based surfactant Fluorad-472 (Sumitomo 3M Ltd.) based on the novolak resin, and 1,000 ppm of 2-(3,5-di-tert-butyl-2-hydroxyphenyl)-2H-benzotriazole as an adhesion improver based on the novolak resin. The mixture was dissolved in propylene glycol monomethyl ether acetate, then stirred and filtered through a 0.2 μm filter to prepare a photosensitive resin composition. This composition was spin-coated onto a 4-inch silicon wafer provided with a Mo (molybdenum) film, and then baked on a hot plate at 100° C. for 90 seconds to give a resist film of 1.5 μm in thickness. This photoresist film was exposed to light by using Stepper FX604F (produced by Nikon) equipped with test patterns having various 1:1 line and space in width, and then developed at 23° C. for 80 seconds with AZ300MIF developing solution (2.38 weight-% aqueous tetramethylammonium hydroxide) manufactured by Clariant (Japan) K.K. When the amount of exposure light by which 5 μm line and space were resolved at 1:1 after the development was assumed to be the optimum amount of exposure light, the optimum amount of exposure light was 40 mJ/cm². Then, the adhesion was confirmed by observing 5 μm, 4 μm and 3 μm line and space patterns under severer conditions, that is, with the amount of exposure light (56 mJ/cm²) which was 1.4-times as high as the optimum amount of exposure light, and ◯ was given when the patterns were not peeled off, Δ was given when the patterns were partially peeled off, and X was given when all patterns were peeled off, to give the results shown in Table 1.

### Comparative Example 1

The same procedure as in Example 1 was carried out except that the adhesion improver was not added, and the results in Table 1 were obtained.

### Comparative Example 2

The same procedure as in Example 1 was carried out except that diethyl(benzotriazol-1-yl)iminomalonate (manufactured by Lancaster) represented by the following general formula (11) was applied in place of 2-(3,5-di-tert-butyl-2-hydroxyphenyl)-2H-benzotriazole, to give the results in Table 1.

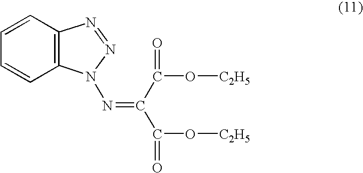

### Comparative Example 3

The same procedure as in Example 1 was carried out except that 1-hydroxyethyl-2-oxy-1,3-imidazoline C₈ to C₁₆ alkanoates (Monazoline C manufactured by Mona Industries; Imidazoline 120H manufactured by Lakeland; etc.) represented by the following general formula (12), typified by 1-hydroxyethyl-2-oxy-1,3-imidazoline laurate, were applied in place of 2-(3,5-di-tert-butyl-2-hydroxyphenyl)-2H-benzotriazole, to give the results in Table 1:

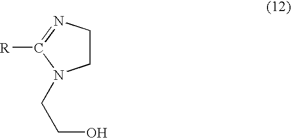

wherein R represents —OCOR′ whereupon R′ represents a C₇ to C₁₅ linear or branched alkyl group.

TABLE 1

| | 5 μm | 4 μm | 3 μm |
|---|---|---|---|
| Example 1 | ◯ | ◯ | ◯ |
| Comparative | X | X | X |
| Example 1 | | | |
| Comparative | ◯ | Δ | X |
| Example 2 | | | |
| Comparative | Δ | X | X |
| Example 3 | | | |

As can be seen from the above results, higher adhesion to a substrate can be achieved by adding the adhesion improver of the present invention than by using benzotriazole or imidazoles known in the art. It can also be seen that the adhesion improver of the present invention is effective on a Mo film whose peeling-off during development is particularly problematic.

Furthermore, the photosensitive resin composition in Example 1 was stored at room temperature for 6 months and then examined in the same manner as above. As a result, deterioration in sensitivity etc. was not observed, and the same results in Example 1 were obtained, and there was no problem in shelf stability.

Effect of Invention

As described above in detail, an excellent photosensitive resin composition showing high adhesion and good shelf stability without pattern peeling-off and pattern collapse observed during development or etching can be obtained in the present invention by adding, to a photosensitive resin composition, an N-phenyl-2H-benzotriazole compound represented by the general formula (1) as the improver for adhesion of a photosensitive resin composition to a substrate. As a result, there can be obtained the extremely excellent effect of solving yield reduction attributable to pattern peeling-off in manufacturing of FPD etc. by using the photosensitive resin composition of the present invention.

### INDUSTRIAL APPLICABILITY

The photosensitive resin composition of the present invention is useful as a resist material for forming an etching mask, anion implantation mask etc. in producing a semiconductor integrated circuit element such as IC and LSI and FPD such as a liquid crystal display element or as a filter forming material in a color filter in manufacturing thereof. Furthermore, the improver for adhesion of a photosensitive resin composition to a substrate according to the present invention is added to a photosensitive resin composition and applied usefully to improve the adhesion of the photosensitive resin composition and a substrate such as a semiconductor circuit element substrate, FPD substrate and color filter substrate.

1. An improver for adhesion of a photosensitive resin composition to a substrate, which consists of an N-phenyl-2H-benzotriazole compound represented by the general formula (1): 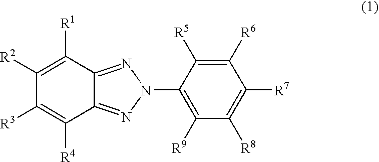
wherein R¹ to R⁴ each independently represent a hydrogen atom, a halogen atom or a C₁₋₅ alkyl group; R⁵ to R⁹ each independently represent a hydrogen atom, a hydroxyl group, a C₁₋₁₀ alkyl group, an aryl group, a C₇₋₁₂ aralkyl group, —R¹⁰C00R¹¹, or —R¹⁰CO—(OCH₂CH₂)ₙ—OH provided that at least one of R⁵ to R⁹ is a hydroxyl group; R¹⁰ represents a C₂₋₅ alkylene group; R¹¹ represents a C₁₋₈ alkyl group; and n is an integer of 2 to 20.

2. A photosensitive resin composition containing an alkali-soluble resin and a photosensitizer, which comprises at least one of N-phenyl-2H-benzotriazole compounds represented by the general formula (1) in claim 1.

3. The photosensitive resin composition according to claim 2, wherein the alkali-soluble resin is a novolak resin, and the photosensitizer is a compound containing a quinonediazide group.

4. The improver for adhesion of a photosensitive resin composition to a substrate according to claim 1, wherein the N-phenyl-2H-benzotriazole compound is selected from the group

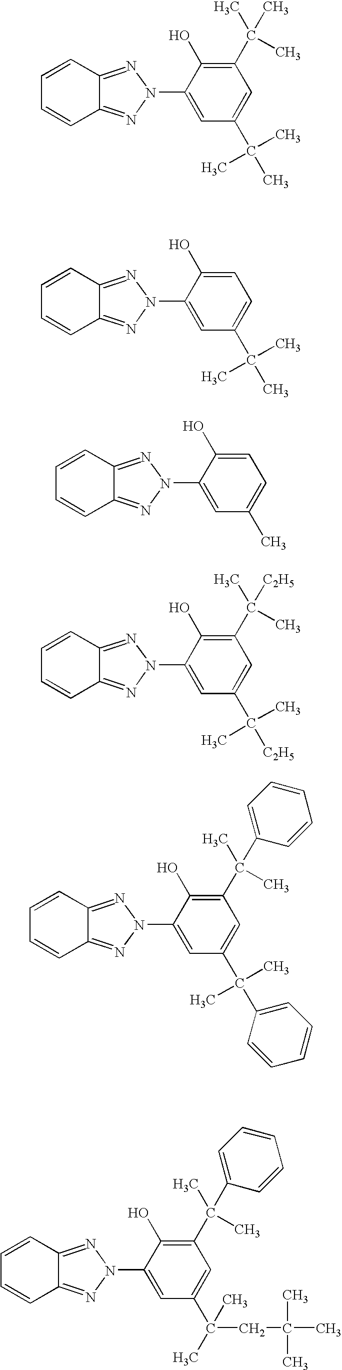

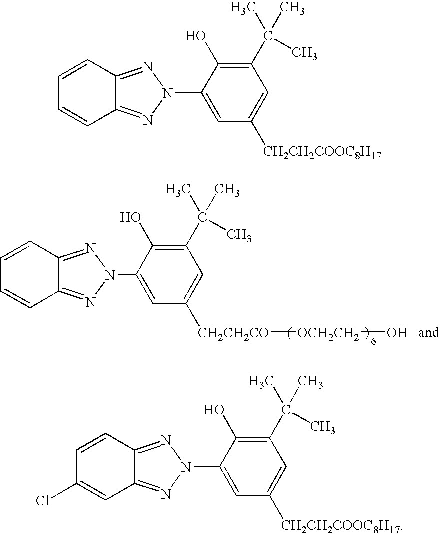

5. The photosensitive resin composition according to claim 2, wherein the alkali-soluble resin is a vinyl polymer having phenolic hydroxyl group or a vinyl polymer having a carboxyl group.
